(19) United States
(12) Patent Application Publication
(10) Pub. No.: US 2006/0022005 A1
(43) Pub. Date: Feb. 2, 2006

(54) EZ carry side basket

(76) Inventor: Barbara E. Chadwick, Flagstaff, AZ (US)

Correspondence Address: BARBARA E. CHADWICK, 8025 LAWRENCE DRIVE, FLAGSTAFF, AZ, 86004, US

(21) Appl. No.: 10/902,738

(22) Filed: Jul. 29, 2004

(51) Int. Cl. B60R 7/00

(52) U.S. Cl. 224/411

(57) ABSTRACT

The EZ Carry Side Basket attaches to either side of the shopping cart and is constructed of a grid type material, whether it is plastic or metal. It is not an integral part of the shopping cart but a basket that attaches to the cart. The basket spans the cart from the top to the rack underneath and provides space for elongated items to be stored while the shopper continues shopping. Currently, shopping carts do not have a place to put elongated items and they stick out of the basket. The elongated items often either interfere with the shopper's maneuverability or cause a hazard for other shoppers. This basket will allow those elongated items to stand straight up next the shopper rather than point out the end of the cart. The basket attaches to the side of the cart and does not interfere with the stacking of carts.

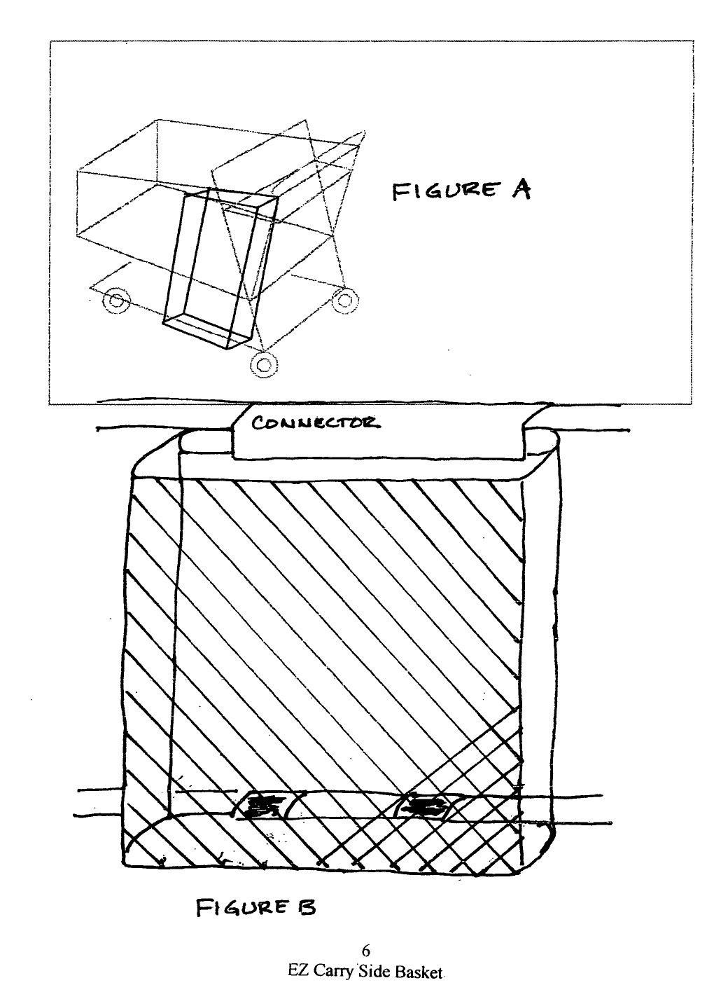

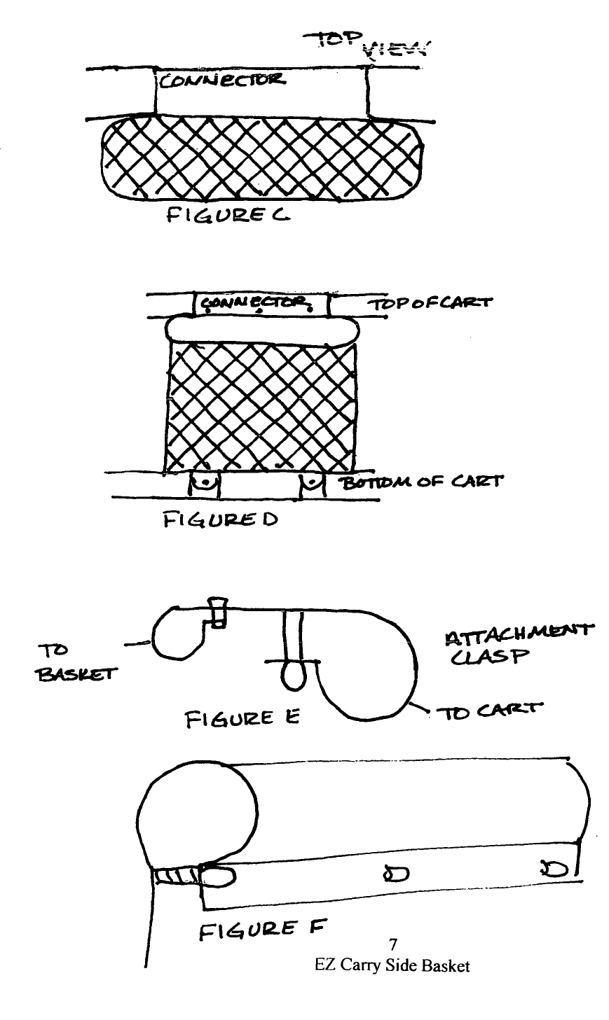

### CROSS-REFERENCE TO RELATED APPLICATIONS

| | | |
|---|---|---|
| 484,666 | December, 2002 | Caya |
| 4204695 | May, 1980 | Salzman |
| 4274567 | June, 1981 | Sawyer |
| 4376502 | March, 1983 | Cohen |
| 4441734 | April, 1984 | Schlissel. |
| 4560096 | December, 1985 | Lucas et al. |
| 489996 | March, 1989 | Freyman |
| 4966318 | October, 1990 | Dutka |
| 5294009 | March, 1994 | Maurer et al. |
| 5362077 | November, 1995 | Adamson |
| 5388854 | February, 1995 | Kappaz |
| 5553876 | September, 1996 | Trubiano |
| D396923 | August, 1998 | Moore |

### BACKGROUND OF THE INVENTION

This claim for patent involves the problem of carrying elongated items in a shopping cart. It also addressed the problem of shopping cart storage. For the purpose of expediency, hereafter the shopping cart will be “cart” and the invention will be called the “basket”. This basket provides the ability to carry elongated items, i.e. lumber, shower curtain rods, etc. The basket is attached to the side of the cart, thus moving the items out of the vision of the shopper. The items will be carried in an upright manner that will eliminate the mobility problems that are now experienced by shoppers. The basket is attached on the side and will not interfere with the stacking and storage of the carts.

### DETAILED DESCRIPTION OF THE INVENTION

This is a single part basket that attaches to the side of a shopping cart to carry elongated items. It will attach at the top and bottom of the cart along the side. The basket is designed to be no more than 14″ long and 5″ wide, to allow for a two by four or other such item to fit. Said basket may be constructed of a frame and a grid type product. Said basket will clamp to the top of the cart and the bottom of the cart frame using metal clamps covered in rubber. The basket will span from the top to the bottom of the cart allowing for better support of the elongated items. The basket is meant to be manufactured alone and attachable to any shopping cart. It is not part of the cart itself. The basket attaches to the cart in such a manner that it does not interfere with the stacking of the shopping carts. It does not interfere with the handle of the cart, as it is meant to be attached behind the handle along the side.

### DRAWINGS

FIG. A shows the basket attached to the cart

FIG. B shows the front elevation of the basket.

FIG. C shows a top view of the basket attached to the cart.

FIG. D shows an additional front elevation with location of screws on connecting piece.

FIG. E shows the bottom attachment clasp for the basket. The clasp is made of metal and coated in rubber. It has holes for screws to attach it to both the basket and the cart.

FIG. F shows the top attachment clasp it a 12″ piece of metal coated with rubber and has holes for screws to attach it to the cart. It is welded to the basket on the bottom of the clasp

1. I claim the invention of the EZ Carry Side Basket. The basket is a single basket that attaches to either side of a shopping cart and is meant to carry elongated items out of the way of the shopper.
